(19) United States
(12) Patent Application Publication
(10) Pub. No.: US 2024/0140020 A1
(43) Pub. Date: May 2, 2024

(54) FREE-FORM FABRICATION OF CONTINUOUS CARBON FIBER COMPOSITES USING ELECTRIC FIELDS

(71) Applicants: The Texas A&M University System, College Station, TX (US); Essentium Inc., Pflugerville, TX (US)

(72) Inventors: Smita Shivraj Dasari, College Station, TX (US); Anubhav Sarmah, Bryan, TX (US); Aniela Wright, Bryan, TX (US); Micah J. Green, College Station, TX (US); Nirup Nagabandi, Pflugerville, TX (US); Daniel Carey, Austin, TX (US)

(73) Assignees: The Texas A&M University System, College Station, TX (US); Essentium Inc., Pflugerville, TX (US)

(21) Appl. No.: 18/384,752

(22) Filed: Oct. 27, 2023

Related U.S. Application Data
(60) Provisional application No. 63/420,530, filed on Oct. 29, 2022.

(51) Int. Cl. B29C 64/118; B29C 70/38; B29C 71/00; B33Y 10/00; B33Y 70/10

(52) U.S. Cl. CPC B29C 64/118; B29C 70/384; B29C 71/0081; B33Y 10/00; B33Y 70/10; B29K 2307/04

(57) ABSTRACT

An out-of-oven system for free-form fabrication of continuous carbon fiber composites includes a dielectric barrier discharge (DBD) applicator configured to create an electric field proximal to the continuous carbon fiber composite. The DBD applicator includes a first electrode disposed within a dielectric barrier, and a second electrode spaced apart from the first electrode. The first and second electrodes are configured to allow the continuous carbon fiber composite to pass therebetween to cure the continuous carbon fiber composite. The system uses Joule heating to cure the continuous carbon fiber composite.

### CROSS-REFERENCE TO RELATED APPLICATIONS

This patent application claims priority from, and incorporates by reference the entire disclosure of, U.S. Provisional Application No. 63/420,530 filed on Oct. 29, 2022.

### TECHNICAL FIELD

The present disclosure relates generally to 3D printing and more particularly, but not by way of limitation, to 3D printing of continuous carbon fiber composites using electric fields.

### BACKGROUND

This section provides background information to facilitate a better understanding of the various aspects of the disclosure. It should be understood that the statements in this section of this document are to be read in this light, and not as admissions of prior art.

Carbon fiber composites have many applications and are quite desirable when both light weight and strength are desired. 3D printing is a relatively recent improvement in the manufacture of carbon fiber composites. Among the benefits of 3D printing is the ability to create complex shapes. Current carbon fiber/thermoset 3D printing processes includes a print head through which a carbon fiber/resin tow is extruded. In existing processes, as the carbon/fiber resin tow is extruded, UV energy is applied to cure the resin and form a solid shape. However, most commercially relevant resins are heat-cured, not UV cured. Current methods for carrying out heat-cured production are limited to large thermal ovens.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

Out-of-oven additive manufacturing (AM) techniques are disclosed that allow for thermosetting carbon fiber reinforced composites (CFRCs) to be printed and rapidly cured using dielectric barrier discharge (DBD)-assisted Joule heating. Conventionally, CFRCs are produced by automated fiber placement machines (AFPs) that use large, cumbersome molds and time-consuming oven/autoclave treatments to cure CFRCs in the desired shapes. Recently, out-of-oven AM has garnered attention as a method to manufacture CFRCs without the use of molds. AM allows for on-the-fly printing and curing of thermosetting CFRCs; however, current out-of-oven AM techniques are limited to UV-curable, low viscosity, or rapid-curing resins. In contrast to conventional methods, the DBD and RF applicators discussed herein provide in-situ heating and curing during AM of continuous CFRCs using electric fields to locally heat resin as it is extruded from a print head of a 3D printer. The electric field is created by a field applicator that generates electric fields proximal to the carbon fiber/resin. Field applicators that may be used include a Radio Frequency (RF) applicator or a Dielectric Barrier Discharge (DBD) applicator. The systems and methods described herein are resin-agnostic, applying to most commercially available thermosetting resins. As the partially cured composite (prepreg) is deposited, Joule heating induced via an RF or DBD applicator allows the part to cure in the desired shape. This is possible because of the conductive carbon fiber susceptors inside the part. Composites manufactured by this method show properties similar to those manufactured in conventional ovens. Using the DBD applicators discussed herein, composites can be printed in free space or on stationary and/or mobile substrates. 2D structures, and 3D multilayered structures can be printed, and the process can be automated. This technology leverages the advantages of AM techniques to enable the printing of high-performance and lightweight materials in any desired shape.

The methods disclosed herein do not require direct contact of the applicator with the carbon fibers. In some aspects, the field applicator and/or print head are stationary and the system includes a means to move the workpiece around (e.g., a conveyor, robotic arm, moving table, etc.). In some aspects, the field applicator and/or print head move around a stationary workpiece (e.g., using a robotic arm or similar to a multi-axis mill).

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a schematic illustrating a DBD applicator system for fabrication of continuous carbon fiber composites using electric fields;

FIG. 2 is a schematic illustrating a DBD applicator system for fabrication of continuous carbon fiber composites using electric fields;

FIG. 3 is a schematic illustrating a DBD applicator system for fabrication of continuous carbon fiber composites using electric fields;

FIG. 4 is a schematic illustrating an RF system for fabrication of continuous carbon fiber composites using electric fields according to aspects of the disclosure; and

FIGS. 5A and 5B are top and perspective views, respectively of a DBD applicator system for fabrication of continuous carbon fiber composites.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The systems and methods disclosed herein allow for the creation of complex, 3D printed structures using continuous carbon fiber composites. In particular, the systems and methods use electric fields to provide heat-cured carbon fiber composites that do not require thermal ovens or molds. Unlike other conventional processes that rely upon UV for curing, the systems and methods cure resin using electric fields generated by an RF applicator or a DBD applicator. The RF system uses a fringing field RF applicator and an RF signal generator to generate an electric field proximal to the workpiece. The print head extrudes the carbon fiber/resin and either the print head or the workpiece moves to create the desired shape. During the printing process, the RF applicator generates an electric field that interacts with the carbon fibers to cure the resin via Joule heating.

Carbon fiber reinforced composites (CFRCs) are lightweight, strong, and corrosion resistant, making them desirable materials that have a wide range of applications in various areas such as defense, marine, aviation, and automotive industries. They can also be used in wind turbines to fabricate blades and structural trusses. In conventional processing of thermosetting CFRCs, automated fiber placement (AFP) machines deposit partially cured CFs in molds of the desired shapes; large, time-consuming ovens, and heat guns are used to heat and completely cure the deposited composite. Creating a mold each time a new shape is designed is a labor intensive and capital-intensive process. Since AFP machines occupy large volumes of space, they are often immobile; they cannot be used locally to create composites. Therefore, there is an increasing necessity to design a compact and convenient method to manufacture CFRCs.

A relatively new development in the production of these composites is out-of-oven AM of continuous carbon fiber composites. Out-of-oven techniques us a nozzle to deposit a carbon fiber prepreg (partially cured carbon fiber/resin tow) in a desired shape, followed by the immediate curing of the resin. However, these approaches typically require non-conventional resin chemistries or UV sensitive resins to achieve rapid curing. However, the majority of the commercially applicable resins are not UV curable.

One promising approach for out-of-oven heating is the use of electric fields. The electrical conductivity of carbon fibers makes them a prime candidate to undergo Joule heating when placed in the influence of external electric fields. The systems and methods described herein demonstrate how carbon fiber prepregs can be manufactured using an electric field generated by a radio frequency applicator. Since the electric field induce heat in the fibers themselves, this method can be used with a range of thermosetting resins surrounding the fibers. Thus, using electric fields to induce heating in the fibers from the inside out is especially useful for processing and manufacturing thermosetting composites. CFRCs can be cured rapidly using electric fields without degrading the fiber-matrix interface.

Another means of applying an electric field is using a DBD applicator. The DBD applicator ionizes the air creating a plasma. The plasma interacts with a polymer having carbon nanotubes as fillers causing them to undergo Joule heating. The DBD applicator includes a top electrode, which contains a dielectric disc. In various aspects, the DBD applicator generates an electric field in the range of about 1-50 kHz (center frequency of 26 kHz typically). The electric field is generated between this top electrode and a bottom ground electrode. The grounded conductive workpiece is placed between the two electrodes. An air gap is maintained between the top electrode and the workpiece. The electric field ionizes the air, and plasma streamers are created in this gap between the workpiece and the surface of the dielectric disk which creates a path for current to flow. When the workpiece connects with the plasma, a discharge current travels through the workpiece, to the bottom electrode. In some aspects, the DBD applicator can be converted into a handheld portable electric field generator.

Reference will now be made to more specific embodiments of the present disclosure and data that provides support for such embodiments. However, it should be noted that the disclosure below is for illustrative purposes only and is not intended to limit the scope of the claimed subject matter in any way.

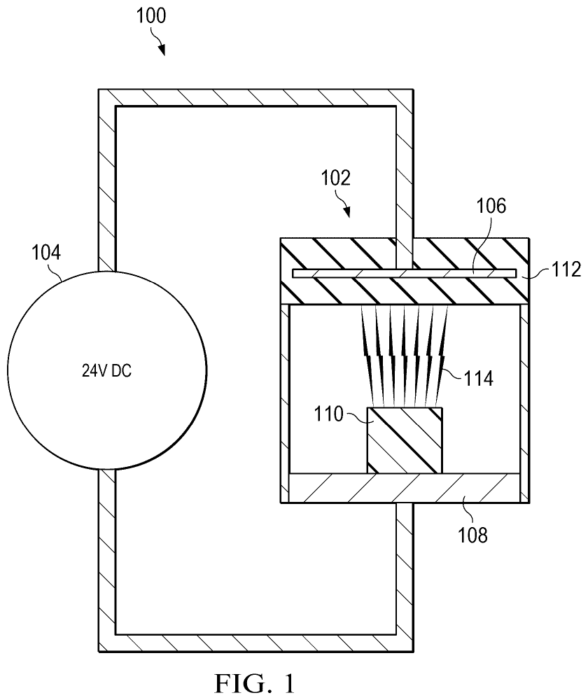

FIG. 1 illustrates a DBD system 100 in accordance with aspects of the disclosure. System 100 includes a DBD applicator 102 that is electrically coupled to a voltage generator 104. DBD applicator 102 includes first and second electrodes 106, 108. First electrode 106 is a high voltage electrode and second electrode 108 is a ground electrode. Voltage generator 104 may be, for example, a 24 V direct current (DC) generator.

A workpiece 110 is positioned between electrodes 106, 108, with an air gap and a dielectric barrier 112 positioned between workpiece 110 and electrode 106. In some aspects, dielectric barrier 112 includes a gold foil with ceramic on top and bottom. Workpiece 110 may be, for example, a carbon fiber/resin extrusion from a print head. In some aspects, the print head and DBD applicator 102 are stationary and workpiece 110 is moved relative thereto to create a structure with the desired shape using additive techniques. In some aspects, workpiece 110 is stationary and the print head and DBD applicator 102 move about workpiece 110 to create a structure with the desired shape. When current is supplied by voltage generator 104, a plasma discharge 114 is formed between high voltage electrode 106 and workpiece 110, and current is allowed to pass between electrodes 106, 108. The resulting electric field heats up the carbon fibers of workpiece 110. This heat is transferred to the surrounding resin, curing the resin. The curing process is carried out without DBD applicator 102 contacting workpiece 110.

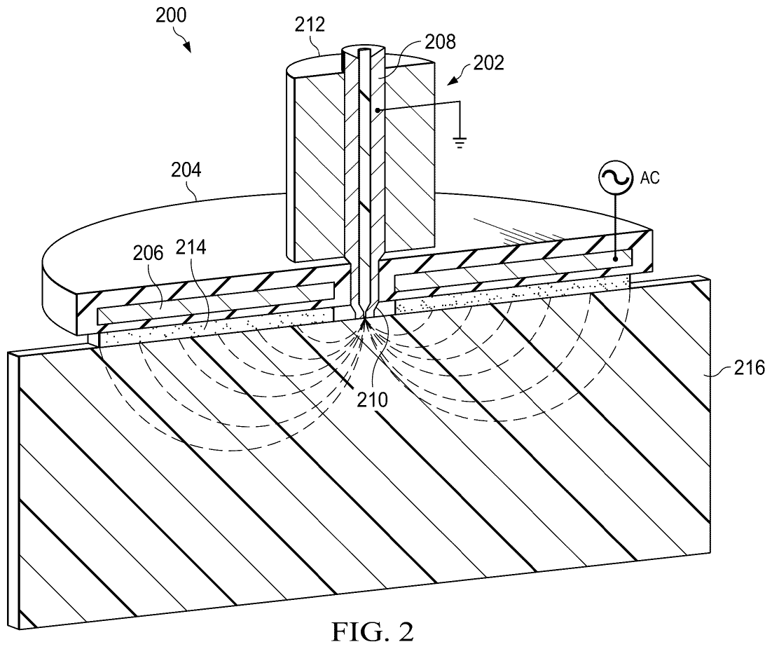

FIG. 2 illustrates a DBD system 200 in accordance with aspects of the disclosure. DBD system 200 operates in a fundamentally similar manner as DBD system 100 and includes a DBD applicator 202 with a pair of electrodes, but the pair of electrodes of DBD applicator 202 are configured differently. A high voltage electrode and dielectric barrier are configured as a dielectric disc 204 that includes a conductor 206 within. A nozzle tube 208 with a nozzle 210 at a distal end thereof extends through the center of dielectric disc 206. Nozzle 210 both provides the carbon fiber/resin material and serves as a grounded electrode. A heater block 212 may be positioned around nozzle tube 208 to heat up the carbon fiber/resin prior to extrusion through nozzle 210. DBD system 200 utilizes alternating current (in contrast to the direct current used in DBD system 100). The dashed lines of FIG. 2 illustrate the electric current that flows between dielectric disc 204 and nozzle 210. When current is flowing, plasma 214 forms between a workpiece 216 and dielectric disc 204. The electric field resulting from the current heats up the carbon fibers of workpiece 216. This heat is transferred to the surrounding resin, curing it. Similar to DBD applicator 102, DBD applicator 202 may be fixed with workpiece 216 moving relative thereto, or may move relative to workpiece 216. The curing process is carried out without DBD applicator 202 contacting workpiece 216.

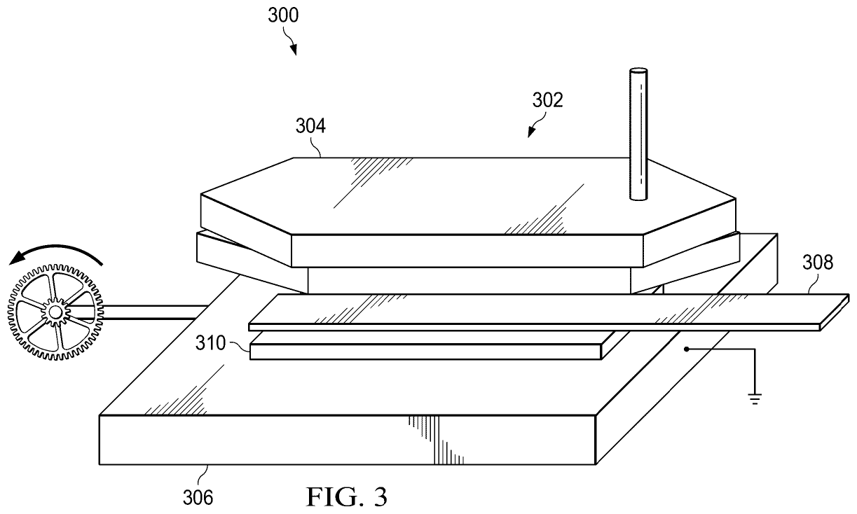

FIG. 3 illustrates a DBD system 300 in accordance with aspects of the disclosure. DBD system 300 includes a BDB applicator 302 with a high voltage electrode inside a dielectric barrier 304 and a ground electrode 306 in the form of an aluminum plate. A workpiece 308 (i.e., the partially cured composite) rests on a conductive substrate 310. Conductive substrate 310 may be, for example, a glass slide wrapped in aluminum foil. In practice, workpiece 308 is extruded by a print head onto substrate 310. As workpiece 308 is extruded, electrode 306 passes beneath DBD applicator 302 to cure the partially cured composite. Similar to the above systems, the electric field created by DBD applicator 302 cures the resin without DBD applicator 302 contacting workpiece 308. The movement of electrode 306 may be used in an additive manufacturing process to build layers. For example, multiple passes may be made, with each pass curing a new layer to build up workpiece 308.

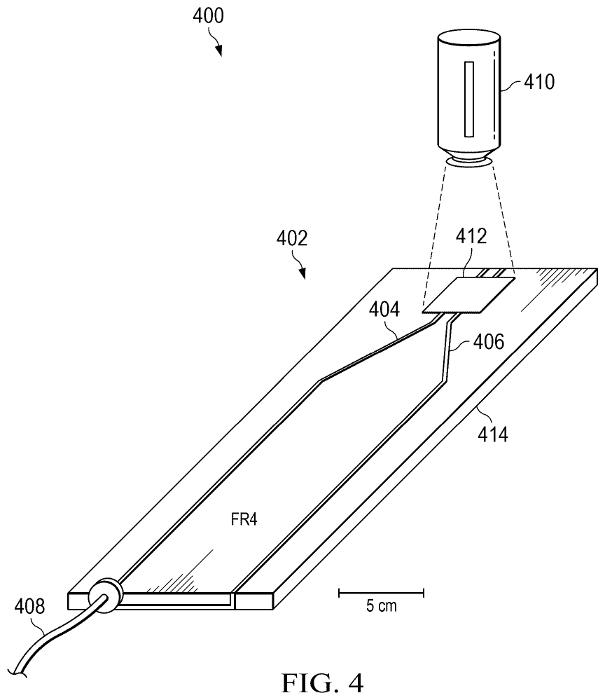

FIG. 4 illustrates an RF system 400 according to aspects of the disclosure. RF system 400 includes a fringing-field applicator 402 that, with a workpiece, behaves like an RLC resonance circuit. RF system 400 includes two copper traces 404, 406 that electrically behave as inductors (L). Copper traces 404, 406 sit on a substrate 414, and an insulating layer (e.g., a layer of Kapton® polyimide tape) is placed on top of copper traces 404, 406. The small air gap between traces 404, 406 acts as a capacitor (C). A workpiece adds a shunt resistance (R) and changes the gap capacitance. An RF source 408 provides a signal to fringing-field applicator 402. A workpiece 412 is shown positioned above the two copper traces 404, 406. The frequency associated with maximum RF absorption is dictated by the dimensions of the applicator. In some aspects, dimensions are selected to obtain RF absorption in the range of 1-250 MHz. The RF electric fields are concentrated in the capacitor air-gap and couple with the conductive workpiece 412 (i.e., the carbon fiber composites). Capacitive coupling induces surface currents which lead to electromagnetic losses and thus heating in workpiece 412. RF system 400 is ideal for thin structures as the electric field strength decays exponentially in the vertical direction. The concentration of the electric fields in the capacitor can be controlled by changing the applied RF power or the size of the gap between the traces. In some aspects, a thermal camera 410 can be used to monitor temperature of workpiece 412 to determine a degree of cure.

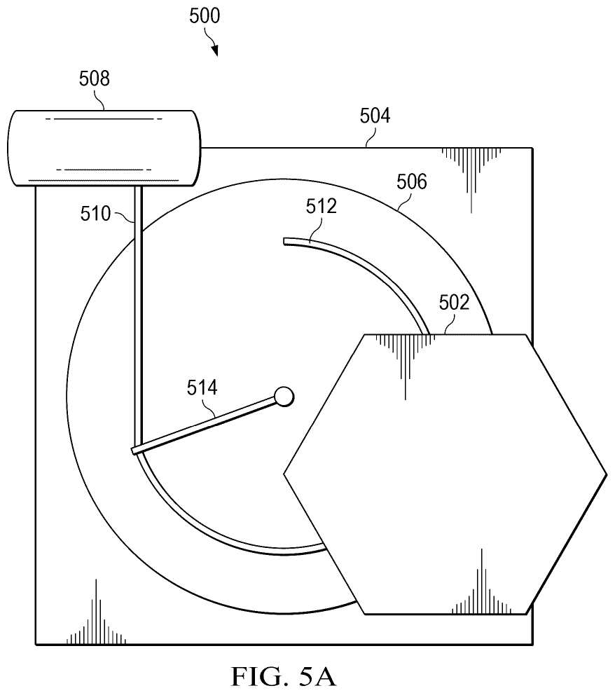

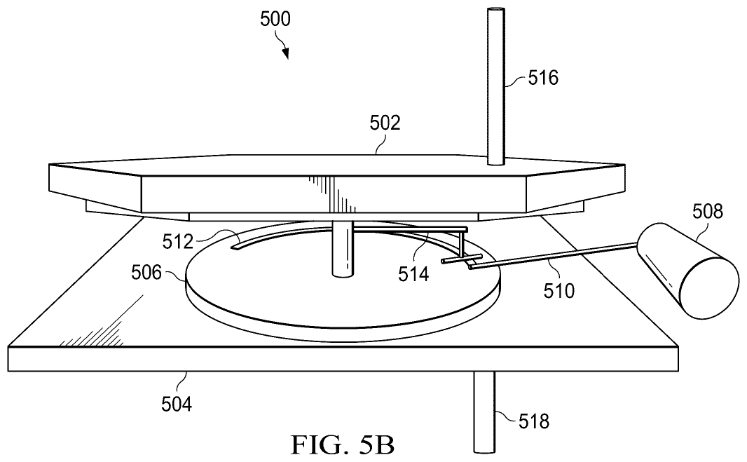

FIGS. 5A and 5B illustrate top and perspective views, respectively, of a DBD system 500 according to aspects of the disclosure. DBD system 500 includes a DBD applicator 502 that is positioned over a stage 506 that is configured to rotate about its central axis. Stage 506 sits on an aluminum plate 504 that acts as a ground electrode. A prepreg spool 508 is positioned proximal to stage 506 and feeds prepreg 510 to stage 506. In some aspects, a stabilizer arm 514 guides and holds prepreg 510 to stage 506 for curing by DBD applicator 502. Stage 506 rotates and pulls out prepreg 510 onto stage 506. As stage 506 rotates, prepreg 510 passes beneath DBD applicator 502 and cures to form cured carbon fiber composite 512. A high voltage supply 516 provides power to DBD applicator 502 and a ground 518 is coupled to aluminum plate 504.

### Working Examples

Materials: T700S unidirectional carbon fibers (Torayca), EPON 828+Jeffamine T403 Hardener (Huntsman).

Preparing prepregs: Continuous unidirectional T700S carbon fiber tows were laid down flat and impregnated with a two-part thermosetting epoxy (EPON 828+Jeffamine T403 Hardener). The impregnated carbon was heated in an oven at 100° C. for 6 min to produce prepregs. These prepregs were then rolled onto a spool. The prepregs were made using the common commercial composition of EPON 828+Jeffamine T403. The curing kinetics of this resin system are known from our prior work, and one can predict the temperature and time needed to cure the resin completely. The curing kinetics of the resin were predicted based on the Kamal-Sourour model. The following parameters were selected for curing to occur at a temperature between 100-110° C.: m=0.402, n=1, and k=0.00542 s⁻¹. A simulation of the kinetic model showed that the prepreg was 65% cured after 6 min at 100° C. For printing multi-layered structures, the prepreg was exposed to plasma from the DBD applicator at 100° C. for an additional 5 min to get to ˜90% cured. When fully curing a given layer (such as a free-standing bridge), the prepreg was exposed to the DBD plasma at 100° C. or above for 8 min to completely cure the sample.

DBD Experiments: A metallic electrode was embedded in a dielectric ceramic disc in the DBD applicator. The ceramic disk was approximately 3 mm thick and 70 mm in diameter. To generate plasma between the dielectric disk and a ground electrode, a 24 V Direct Current (DC) power was supplied to a frequency and power modulation device using a NICE-POWER DC Power Supply (Model: R-SPS3010). A high ratio winding transformer (286:1) received the frequency generator's 24 V peak-to-peak 25-32 kHz modulated square wave signal, and output a corresponding high voltage (8-10 kV) modulated signal to the ceramic disc applicator. A thermal camera (FLIR Systems Inc., A655sc) was used to observe the temperature of the sample from the side.

Preparing a continuous CFRC using DBD: The prepreg was dispensed through the DBD-generated plasma using a motor. For fabricating a suspended workpiece, a grounded copper wire was attached to the prepreg. For fabricating a workpiece on a substrate, the prepreg was laid on a grounded aluminum plate. To completely cure a prepreg, the prepreg was exposed to the plasma for 8 minutes at 100° C. The heating zone has a length of 50 mm. The translation speed of the prepregs was 6.25 mm/min.

The distance between the grounded prepreg and the DBD applicator was varied between 0-7 mm. The heating rate of the prepreg at each 1 mm incremental distance was recorded.

### Fabricating Multilayered Structures

Additive manufacturing using in-situ curing: A first layer of prepreg was dispensed and laid across a ground plate. Based on the kinetics, at 107° C. the prepreg cured completely in 7 min. The resin needs to be only partially cured so that it can bond with the next layer. Thus, the first layer was cured for 5 minutes at 107° C. using the DBD applicator. The duty cycle was varied to maintain a temperature of 107° C. A second layer of prepreg was then laid on top of the previous layer. The second layer was cured for 5 minutes as well at 107° C., so that the third layer can bond with it. This process was repeated to create multiple layers.

Additive manufacturing using post cure: A first layer of prepreg was dispensed and laid across the ground plate. The second layer was then directly laid across the first layer. Similarly, the third, fourth and fifth layers were laid on top of the preceding layer. The entire structure was then exposed to the plasma for 25 minutes. The power of the DBD applicator was modulated to maintain the temperature of the top layer at 107° C.

Complex shapes: Multiple prepreg layers were moved relative to the DBD applicator by using an automated stage. The prepregs were deposited in the desired complex shapes and the layers were consolidated using rollers. The prepregs were then cured using the DBD generated plasma. For fabricating a multilayered rectangular composite, the prepreg layers were additively printed with DBD-assisted in-situ curing for 8 minutes each (at 100° C.) before printing the subsequent layer. For fabricating the helix, each prepreg layer was printed and in-situ cured using the DBD for 5 minutes each at 107° C. before printing the next layer. The next layer was offset by a slight angle)(<15°. For fabricating the circle, a pressing roller was used to consolidate the prepreg that was being deposited on the automatic rotating stage.

### Characterization

Differential Scanning calorimetry: The glass transition temperatures and degrees of cure of samples were calculated using differential scanning calorimetry (DSC). These experiments were conducted using a TA Instruments DSC Q20 (New Castle, DE). The samples contained 3-5 mg of substance total. Nitrogen was used to purge the test chamber at a rate of 50 mL/min. The temperature was ramped up from room temperature to 200° C. at a rate of 3° C./min. For multilayered structures, a cross section cutting across all layers (5 layers) was used for testing. The samples were transported in a 0° C. container to prevent any curing at room temperature.

Mechanical Testing: Each sample for a lap shear test consisted of two unidirectional T700S CF prepreg tow pieces having a length of 5 cm and width of 0.8 cm, placed one on top of the other such that the overlap area had dimensions of 0.8 cm×0.8 cm. The two samples were completely cured at 100° C. for 14 minutes in the oven and using the DBD applicator. An Instron load frame with a 30 kN load cell was used for these tests; the displacement rate was set at 2 mm/min for all tests. ILSS assessment was carried out as per ASTM 2344 standards. The sample thickness was maintained at 4 mm, width at 8 mm, and length at 16 mm. A strain rate of 1 mm/min was used. The short beam strength was calculated using Equation 1 below:

F=0.75*Pₘ/(b*h) Equation 1

Where Pₘ is maximum load observed during the test in N, F=short-beam strength in MPa b=measured specimen width in mm, and h=measured specimen thickness in mm.

Thermogravimetric Analysis (TGA): TGA measurements were done in a TA Instruments TGA 5500 in air to determine the mass fraction of the composites. The sample was loaded on a Platinum pan and temperature was ramped from room temperature to 400° C. at a rate of 20° C./min, then the temperature was held constant to observe degradation of the epoxy matrix.

Scanning Electron Microscopy (SEM): The cross-sections of 2 composites manufactured using the DBD-assisted method were polished and observed with a FEI Quanta 600 field-emission scanning electron microscope. For imaging, the cross-section image was divided into 9 sections and ImageJ software was used to calculate volume fraction and void fraction.

Results: electric fields were evaluated to determine if prepregs can cure during deposition to create freestanding CFRCs. To produce prepregs, continuous unidirectional carbon fiber tows were impregnated with epoxy and partially cured at 100° C. for 6 minutes in an oven. These prepregs were then rolled onto spools. These prepregs were then dispensed through the DBD-generated plasma. For as long as the tow is in the heating zone (residence time), the plasma couples with the CFs such that the CFs are heated and the surrounding epoxy cures. The DBD power was modulated in order to achieve a target temperature (100-110° C.). The curing kinetics of this resin system were used to predict the temperature and time needed to cure the resin completely. As described below, several different methodologies were used to dispense the prepreg and build up multilayered structures. In a commercial setting, this technology would be controlled by a robotic arm that dispenses prepregs with DBD-assisted in-situ curing to create self-supporting structures.

The DBD-assisted Joule heating method was first used to cure a stationary prepreg at a given temperature. A prepreg was laid on a grounded aluminum plate and was exposed to the DBD generated plasma. The sample underwent Joule heating and reached a steady state temperature of 100° C. when an input power of 35 W was applied to the DBD applicator. The prepreg sample was kept at this temperature for 8 minutes. To verify that the DBD-assisted Joule heating would completely cure the sample as expected, DSC measurements were carried out on the prepreg sample before and after exposure to DBD generated plasma.

DSC data confirmed that the kinetic model can be used successfully to predict the degree of cure of a sample, if the time and temperature are known. To completely cure a composite, the prepreg was heated at or above 100° C. for 8 min or longer. To create a multilayered structure, the first layer was heated at 100° C. (wall) & 107° C. (helix) for only 5 min so that it could bond to the next layer (discussed below). TGA in air was carried out on the completely cured composite. The CFs make up 55 wt % of the composite. The epoxy matrix burned off completely beyond 400° C. Based on the SEM images of the cross-section of the composites, it was observed that the fiber distribution was fairly uniform, with only a few voids present. The areal density calculations showed that CFs have a volume fraction of 63%. The void fraction was found to be 2.4%.

Next, the DBD applicator was used to create composites that held their shape in air without sagging or bending. A suspended continuous prepreg sample was unspooled and dispensed at a constant speed (6.25 mm/min) through the DBD generated plasma to rapidly heat and cure. The heating zone has a length of 50 mm. Thus, the prepreg is exposed to the plasma for 8 minutes. The prepreg remained suspended under tension with the help of a motor. This pulling motion of the motor also unspools the prepreg in the desired direction. In this case, a grounded copper wire brush was kept in contact with one end of the prepreg. The power was modulated to maintain the sample at a temperature of 100° C. (average power 35 W). The sample cured completely to form a stiff, suspended composite. This demonstrated that this technique can be used to create freeform self-supporting structures.

Next, the effect of the distance between the grounded sample and the DBD applicator (top electrode) was examined. This distance was varied from 0 mm to 7 mm, and the heating rates of the prepreg were recorded at each distance. The heating rate was highest when the sample was closest to the top electrode, as expected. Beyond a certain spacing (5 mm), plasma is not formed between the sample and the DBD applicator, i.e., no ionization of air occurs. This implies that the applicator needs to be within 5 mm of the sample for plasma to form and the sample to heat and cure.

DBD-assisted Joule heating can also be used to produce multilayer structures. In order to do so, the degree of cure must be controlled for each layer. If a given layer is insufficiently cured, the part will not hold its shape; however, if a given layer is completely cured, it will not bond to the next deposited layer. To investigate this phenomenon, the residence time of the first layer was varied, and lap shear tests were conducted to measure interfacial shear strength. Note that the temperature was maintained at ˜100° C. during this experiment. As expected, the data showed that the longer a layer is cured before laying another prepreg layer on top, the weaker the interfacial adhesion between the two layers is. To balance these two design considerations (maintaining shape and interfacial bond strength), a residence time of 5 minutes was selected for all experiments where multilayered structures were made. The simulation of the kinetic model showed that when the prepreg was made, it is 65% cured after 6 min at 100° C. When the prepreg was exposed to the DBD plasma at 100° C. for an additional 5 min, it was ˜90% cured. Similarly, when the prepreg is exposed to 107° C. for an additional 5 min it was ˜92% cured.

DSC data of heat flow versus temperature for a 5-layer wall structure that was additively manufactured with a DBD-assisted in-situ cure cycle where the average temperature was maintained at 107° C. was collected. The area under the exotherm in the DSC plot for the samples before and after exposure to the plasma was measured and compared to the area under the exotherm of a completely uncured sample. The mathematical relation to find degree of cure using DSC is shown in Equation 2 below:

$$α = 1 - \frac{Δ {H}_{t}}{Δ {H}_{0}} \qquad Equation 2$$

where α is degree of cure, ΔHₜ is the heat released during curing (obtained by area under the exotherm in DSC plot) of a sample with plasma exposure time t, and ΔH0 is the heat released during curing of a completely uncured sample.

In-situ curing allowed for each CF prepreg tow layer to cure for 5 minutes at 107° C. and retain its shape before a new layer was placed on top of it. Data confirmed the kinetic model prediction that the first layer cured to an α=˜0.92 when the prepreg is exposed to 100° C. for an additional 5 min. Then, the second layer was deposited on top of the first layer, followed by an additional 5 minutes of plasma exposure. While the second layer cured partially, the first layer cured completely due to heat conduction from the top layer. Similarly, a third, fourth, and fifth layer were deposited and cured. With this technique, a post-cure step in an oven is not needed to completely cure the entire structure. The DSC of a cross-sectional slice of the DBD-manufactured multilayered composite (consisting of all 5 layers) shows that the degree of cure was 1.

Next, the DBD-assisted Joule heating approach was used to produce a multilayered structure (a wall) of 20 CF tow layers. The structure retained its shape, and had flat and smooth edges, and sharp corners. For this method of additive manufacturing to be incorporated in industry, the mechanical properties of the fabricated structures using the DBD have to be similar to those fabricated conventionally. Lap shear tests were conducted on 2 samples: a sample manufactured through the DBD-assisted process and a sample cured in the oven. Both samples were cured at 100° C. for 14 minutes to ensure that they are completely cured. The two samples showed comparable shear strength of around 30 MPa. ILSS tests were also carried out to compare the short beam strength of the composite manufactured using oven and DBD. Thus, the multilayered structures fabricated using DBD-assisted Joule heating show similar mechanical strength to those fabricated in an oven.

Using this method, one can also create 3-dimensional self-supporting structures in air. A helical structure with overhang was fabricated using the DBD-assisted in-situ curing. The helix was created by depositing layers of prepreg successively along a central axis. Each new layer was rotated at an angle of 5° before deposition. Every layer was cured for 5 minutes at 107° C. before depositing a new layer on top.

Several structures of different shapes were created to demonstrate the practical use of the DBD applicator. In some aspects, the shapes can be laid by hand and cured using the DBD-assisted Joule heating method. This method can be used to create shapes with curved edges and/or straight edges. The symmetry and precision of creating a shape using this method depends on the accuracy with which the prepregs can be deposited.

To automate this AM process, a circular CFRC ring was fabricated using a stage that moved relative to the stationary DBD applicator (see FIGS. 5A and 5B). The prepreg is deposited on the rotary stage and the stage simultaneously moves in a predetermined path to create the desired geometry. The stage had a stationary roller which pressed down on the as-deposited prepreg to guide the unspooled prepreg and consolidate the new layer onto prior layers. As the prepreg passes through the DBD applicator, the sample is heated and cured in the desired shape. Another approach that was explored was using a robotic arm to make a hands-free setup. The robot can pull or deposit the prepreg in the desired shape.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A system for free-form fabrication of continuous carbon fiber composites, the system comprising:
a dielectric barrier discharge (DBD) applicator configured to create an electric field proximal to the continuous carbon fiber composite, the DBD applicator comprising:
a first electrode disposed within a dielectric barrier; and
a second electrode spaced apart from the first electrode,
wherein the first and second electrodes are configured to allow the continuous carbon fiber composite to pass therebetween to cure the continuous carbon fiber composite.

2. The system of claim 1, further comprising a direct current generator electrically coupled to the first and second electrodes.

3. The system of claim 1, wherein the first electrode, the second electrode, and the dielectric barrier are configured to generate a plasma between the first electrode and the uncured carbon fiber composite.

4. The system of claim 1, further comprising an alternating current generator electrically coupled to the first and second electrodes.

5. The system of claim 4, wherein the dielectric barrier comprises a dielectric disc and the second electrode forms part of a nozzle tube that extends through the dielectric disc.

6. The system of claim 5, further comprising a heater block disposed around the nozzle tube and configured to heat the continuous carbon fiber composite as it flows through the nozzle tube.

7. The system of claim 6, wherein the dielectric disc comprises a conductor disposed within the dielectric disc.

8. The system of claim 1, wherein the second electrode forms at least part of a plate that is configured to move relative to the first electrode.

9. The system of claim 1, wherein the first electrode is configured to move relative to the continuous carbon fiber composite.

10. The system of claim 1, further comprising a conductive substrate upon which the continuous carbon fiber composite rests after being extruded by a print head.

11. The system of claim 1, further comprising a stage that is configured to receive the continuous carbon fiber composite and to move relative to the DBD applicator such that the continuous carbon fiber passes between the first and second electrodes.

12. The system of claim 11, further comprising a stabilizer arm that contacts the continuous carbon fiber composite and presses the continuous carbon fiber composite onto the stage.

13. A system for free-form fabrication of continuous carbon fiber composites, the system comprising:
a radio frequency (RF) applicator comprising a pair of copper traces disposed on a substrate; and
an RF source coupled to the pair of copper traces and configured to supply an RF signal to the pair of copper traces to generate an electric field proximal to the continuous carbon fiber composite.

14. The system of claim 13, further comprising a thermal camera positioned proximal to the RF applicator and configured to measure a temperature of the continuous carbon fiber composite as it passes over the pair of copper traces.

15. The system of claim 13, further comprising an insulating layer on top of the pair of copper traces.

16. The system of claim 13, wherein the continuous carbon fiber composite provides a shunt resistance that changes a gap capacitance between the pair of copper traces.

17. A method of free-form fabrication of continuous carbon fiber composites, the method comprising:
passing a first layer of the continuous carbon fiber composite proximal to a dielectric barrier discharge (DBD) applicator configured to create an electric field proximal to the first layer of the continuous carbon fiber composite, the DBD applicator comprising:
a first electrode disposed within a dielectric barrier; and
a second electrode spaced apart from the first electrode;
generating a plasma via the DBD applicator;
contacting the first layer of the continuous carbon fiber composite with the plasma to create an electric field proximal to the first layer of the continuous carbon fiber to create Joule heating in the first layer of the continuous carbon fiber composite to cure the first layer of continuous carbon fiber composite.

18. The method of claim 17, further comprising:
placing a second layer of partially cured continuous carbon fiber composite on the cured first layer of continuous carbon fiber composite;
passing the second layer of partially cured continuous carbon fiber composite proximal to the DBD applicator to cure the second layer of partially cured continuous carbon fiber composite.

19. The method of claim 17, wherein the dielectric barrier comprises a dielectric disc and the second electrode forms part of a nozzle tube that extends through the dielectric disc.

20. The method of claim 17, further comprising a stage that is configured to receive the continuous carbon fiber composite and to move relative to the DBD applicator such that the continuous carbon fiber passes between the first and second electrodes.
